(19) United States
(12) Patent Application Publication
(10) Pub. No.: US 2026/0257307 A1
(43) Pub. Date: Sep. 3, 2026

(54) SPHERICAL CLAMP

(71) Applicant: ZEROCLAMP GmbH, Bruckmühl (DE)

(72) Inventor: Klaus Hofmann, Bruck (DE)

(21) Appl. No.: 18/839,101

(22) PCT Filed: Feb. 16, 2023
(86) PCT No.: PCT/DE2023/100128

§ 371 Date: Aug. 16, 2024

(30) Foreign Application Priority Data
Feb. 17, 2022 (DE) 10 2022 103 709.6

(51) Int. Cl. B23Q 1/32

(52) U.S. Cl. CPC B23Q 1/32

(57) ABSTRACT

The invention relates to a spherical clamp fixable in a machine bed for releasably clamping workpieces, wherein a shaft guided in the spherical clamp remains connected to the workpiece via a fastening means, while a clamping joint formed with a spherical socket and a spherical fastener receiving the shaft can be selectively fixed or released in order to allow a relative movement of the workpiece in the released state and, by subsequent clamping, its fixation in the newly occupied position.

### REFERENCE TO PENDING PRIOR PATENT APPLICATIONS

This patent application is a 371 national stage entry of pending prior International (PCT) Patent Application No. PCT/DE2023/100128, filed 16 Feb. 2023 by Zeroclamp GmbH for SPHERICAL CLAMP, which patent application, in turn, claims benefit of German Patent Application No. DE 10 2022 103 709.6, filed 17 Feb. 2022.

The two (2) above-identified patent applications are hereby incorporated herein by reference.

### FIELD OF THE INVENTION

The present invention relates to a spherical clamp for releasably clamping workpieces.

### BACKGROUND OF THE INVENTION

It is often necessary to machine workpieces to maintain specified target dimensions, for which reason they are usually clamped in a machine bed using clamping means, for example. It is possible for internal stresses within the workpiece to be released by the machining, and to subsequently seek to deform the clamped workpiece in order to compensate for these internal stresses. The deformation takes place when the clamping means are released, and for machining to target dimensions the deformed workpiece must be reclamped and reworked. Carrying out the clamping again, in particular when multiple clamping means are used at various sections of the workpiece, is very complicated, since due to the deformation the spatial location of the engagement points of the clamping means on the workpiece relative to one another and/or with respect to an unchangeable reference point generally changes. The clamping means must be adjusted in each case for these factors.

A device for releasably fixing a workpiece as well as an associated method are known from WO 2021/000977 A1. A spherical, multipart ball bearing which is penetrated centrally by a shaft to be clamped is acted on radially by pneumatically actuatable clamping elements in order to clamp the shaft. However, in the clamped state the shaft is not very well secured against displacement.

The object of the invention, therefore, is to provide a clamping means and a method for its use which simplify and speed up the (re)clamping of a workpiece and the taking into account of deformations due to internal stresses during the machining.

### SUMMARY OF THE INVENTION

The object is achieved by a spherical clamp according to claim 1 or a method according to claim 7. Further advantageous embodiments result from the subclaims.

The invention initially proceeds from the observation that when workpieces are machined, they may release internal stresses that are not compensated for as long as the workpiece remains clamped after the machining (clamping position). After the clamping means are released, individual workpiece sections carry out a rotation and/or displacement relative to their previous position until, as a result of the deformation and the accompanying reduction or compensation of the stresses, they occupy a new position and location in space (compensating position). The invention is based on the concept of participating in carrying out these compensating movements from the clamping position into the compensating position in a released state of the clamping means, so that after the subsequent transfer into a clamped state the workpiece may once again be fixed in the compensating position, thus simplifying the reclamping.

The clamping means according to the invention is a spherical clamp according to claim 1. The spherical clamp includes a fastening means that is connectable to the workpiece to allow the workpiece to be positioned and fixed relative to the spherical clamp. The fastening means is coupled to further elements of the spherical clamp, and in a released state is movable relative to these components, whereas in a clamped state it is immovable. The spherical clamp itself may be situated in a machine bed, or may be clamped and remain there without having to change its position, even when the workpiece deforms to reduce internal stresses and the fastening means participates in carrying out this relative movement.

For this purpose, the spherical clamp according to the invention includes a shaft that is provided around an axis and that has fastening means at one end, via which the workpiece to be clamped is connected. In addition, the spherical clamp includes a ball clamp which with an inner side rests, directly or via clamping jaws, against a cylindrical section of the shaft. The ball clamp, with its inner side directed toward the shaft, may slide along the cylindrical surface of the shaft, preferably with little radial play. The outer side of the ball clamp has a spherical shape about an imaginary midpoint situated on the axis of the shaft.

On its outer side, the ball clamp is enclosed by a ball socket, which with its (preferably likewise spherical) inner side rests against the spherical outer side of the ball clamp, preferably likewise with little radial play. The spherical inner side of the ball socket and the spherical outer side of the ball clamp preferably have the same center of curvature M. The inner side of the ball socket is able to slide multiaxially on the spherical outer side of the ball clamp, thus allowing any desired swivel movements of the ball clamp relative to the ball socket.

According to the invention, the spherical clamp, in particular its ball socket, is movable from a clamped state, along or opposite to a clamping direction X, into a released state and back in order to exert or release a clamping force on the ball clamp and the shaft. In the released state the shaft is displaceable, preferably also rotatable, relative to the ball clamp, and the ball clamp may be swiveled about the midpoint M, relative to the ball socket. In contrast, in the clamped state the ball socket exerts a pressing force on the interior ball clamp in the radial direction, and the ball clamp thus clamps the shaft in the radial direction. A relative movement between the ball socket, ball clamp, and shaft is then no longer possible due to the frictional force, generated from the pressing force, between the clamped-together components.

As a result, in the released state the shaft may be displaced along its axis and swiveled about the axis, and may also be arbitrarily swiveled about the midpoint M. The invention makes use of this property to enable compensating movements of the workpiece from the clamping position into the compensating position, while the workpiece remains connected to the spherical clamp via the fastening means. After the compensating position is occupied, the shaft together with the workpiece it carries may be easily and quickly re-fixed by again generating the clamping force, as explained below.

The ball clamp must be designed in such a way that it is able to transmit a clamping force, exerted on it by the ball socket, to the interior shaft. For this purpose, it is necessary that sections of the ball clamp can carry out a certain, even if minimal, radial movement to allow the shaft to be securely clamped. In a particularly simple case, the ball clamp may be formed with an essentially spherical body having a central through hole for accommodating the shaft, the spherical body having at least one slot in the circumferential direction that allows elastic deformation of the body in the circumferential direction, and thus also in the radial direction, when the body is acted on by a pressing force on its outer side.

Alternatively and preferably, the ball clamp includes multiple ball clamp elements situated partially or completely separate from one another and preferably situated uniformly around the shaft in the circumferential direction. Each of these ball clamp elements on its inner side has a cylindrical face for resting against the shaft; this face may also be formed by or with the aid of clamping jaws in order to achieve a particularly good clamping effect. On the outer side, each ball clamp element is provided with a spherical face section that is able to slide on the inner side of the ball socket and thereby swivel about the midpoint M. Individual ball clamp elements that are separate or separable from one another may be easily replaced for maintenance purposes, for example, and allow easy access to the interior clamping jaws, if present.

According to the invention, the ball socket is also formed by multiple ball socket elements that are partially or completely separate from one another and situated around the ball clamp in the circumferential direction. Each of these ball socket elements has a spherically shaped inner side for resting against the ball clamp or its individual ball clamp elements, and is optionally equipped with clamping jaws for particularly reliable transmission of force. On their outer side the individual ball socket elements are preferably provided with coupling means for absorbing the clamping force introduced into them.

The clamping force may be introduced to the ball socket or its ball socket elements via clamping means that are actuated pneumatically, hydraulically, or electromechanically, for example. In principle, it may be sufficient for the ball socket to be acted on by a clamping force in only one direction in order to achieve the desired clamping effect between the ball socket, ball clamp, and shaft. The clamping force is preferably directed toward the shaft axis or the midpoint M.

In contrast, one particularly effective alternative provides that the clamping force is exerted on the ball socket on all sides in the radial direction along a circumference, so that the ball socket is pressed radially inwardly over its entire circumference in order to achieve a homogeneous clamping effect, and in particular to avoid lateral shifting of the shaft when force acts only on one side. According to the invention, the ball socket is designed so that the ball clamp is simultaneously acted on by force above and below an equatorial plane, resulting overall in a three-dimensional action of force or deformation of the ball socket (and correspondingly, also of the ball clamp) in the radial direction, inwardly toward the shaft. With a suitably large clamping force, the largest possible contact surface between the ball socket, ball clamp, and shaft results in particularly secure locking of the components relative to one another.

For generating the clamping force, one particularly advantageous embodiment of the spherical clamp provides for clamping means in the form of one, preferably multiple, radial spring(s) that may be actuated hydraulically, for example, but preferably pneumatically. For this purpose, the spherical clamp includes a housing preferably having an essentially rotationally symmetrical design about a central axis Z₀. The housing is designed to be fastened to a machine bed in order to machine a workpiece, held by the spherical clamp, by use of the machine. In the housing the radial springs are situated around the housing axis. The radial springs each contain a chamber that is enclosed by spring elements, and that may be acted on by a fluid, in particular compressed air. Under the action of pressure, the chamber extends in a direction parallel to the housing axis, and at the same time its extension orthogonally thereto, i.e., in the radial direction, is shortened. This extension takes place against an elastic force that is inherent to the radial spring, which subsequently seeks to deform the spring back into its radially extended starting position. In the event of a pressure drop, the radial spring therefore once again extends in the radial direction, following its elastic force. When the radial spring is supported along its outer circumference on an inner wall of the housing, the inner circumference of the radial spring moves to a certain extent toward or away from the central housing axis, depending on the action of pressure. Depending on the design of the radial springs and their elastic force, high forces in the radial direction may be generated at the inner circumference.

According to the invention, the at least one radial spring with its inner circumference or a section thereof is in operative connection with the ball socket. In the clamped state, the radial spring generates a radially inwardly directed clamping force on the ball socket, as a result of which the ball clamp, which is acted on by the ball socket, clamps the shaft that is encompassed by the ball clamp. The frictional forces generated between the ball socket, ball clamp, and shaft by the clamping force ensure that the shaft is securely clamped relative to the housing, against rotational movements about the shaft axis, swivel movements about the midpoint, and displacements in the direction of the shaft axis; its position and location in space is then fixed. In contrast, if the clamping force is eliminated due to the action of pressure and subsequent radial contraction of the radial spring (released state), the shaft may be freely moved and realigned in the above-mentioned directions.

According to the invention, it should be ensured that the shaft in the clamped state is held free of play. In particular, slight movability or play along the shaft axis should be prevented. Since the ball clamp or its individual elements, as well as the ball socket or the individual ball socket elements, are pressed (slightly) radially inwardly toward the shaft during the clamping and are possibly easily deformed, it must be ensured that this radially inward movement or deformation results in the smallest possible amount of axial play of the ball clamp and the ball socket relative to the housing, as a result of which the shaft itself, although clamped, would likewise have little play. According to the invention, it is provided to guide the ball socket, acting on the ball clamp, along at least one stop surface in its movement between the clamped state and the released state, so that the ball socket cannot yield perpendicular to this movement direction (clamping direction X). This guiding, in particular when it is provided on both sides above and below the ball socket, on the one hand prevents yielding (play) of the ball socket (together with the clamp and shaft) perpendicular to the clamping direction. On the other hand, widening of the ball socket perpendicular to the clamping direction or flattening in the direction is prevented when the ball socket is supported on at least one side by a stop surface and its shape is maintained.

Since the ball socket or the socket elements has/have spherical inner faces with which the ball clamp or its elements engage with their outer faces (preferably in a complementary manner), the ball clamp in the clamped state is also fixed free of play due to the guiding of the ball socket or its socket elements along the stop, so that the shaft itself also has no axial play.

In terms of construction, for this guiding at least one stop surface H is provided according to the invention, along which the ball socket or individual ball socket elements slide(s) or is/are guided in the clamping direction X. The stop surface extends along the clamping direction X, preferably as a plane that is orthogonal with respect to the housing axis Z₀. The stop surface may be designed as a stop surface in or at the housing of the spherical clamp. In a housing having an essentially rotationally symmetrical design, the stop surface may be designed as a circumferential step or shoulder extending around the housing axis Z₀. (For multiple ball socket elements that are circumferentially situated around the housing axis Z₀, an independent, in each case radially inwardly extending, clamping direction X is associated with each element.) Two stop surfaces extending flatly in parallel and opposite one another in the axial direction are preferably provided, between which the ball socket or its individual ball socket elements is/are guided free of play in the radial direction. According to the invention, the ball socket includes multiple ball socket elements lying on top of one another in the direction of the housing axis Z₀. These may likewise form stop surfaces H′ between them in order to support or stabilize one another in the axial direction.

The fastening means situated at the shaft preferably includes a bearing for absorbing swivel movements carried out by the workpiece relative to the shaft during the transfer from the clamping position into the compensating position. This is preferably a straightforward swivel bearing that permits no displacement. In particular, this may be a ball joint or a (metal) bellows having a similar action. One section of the joint is connected to the shaft, while the section that is swivelable relative to the shaft is designed to be fastened to the workpiece, for example in the form of a fixing pin that can be screwed to the workpiece or connected in some other way.

In the released state, such a swivel bearing in combination with the second bearing formed from the ball socket, ball clamp, and the shaft that is displaceable therein allows the completely free movement of the workpiece from the clamping position into the compensating position, as well as simple subsequent fixing. The laborious and complicated reclamping of a machined workpiece after being deformed, known from the prior art, often with the alignment and actuation of numerous individual clamping elements, may thus advantageously be speeded up and automated. This becomes particularly apparent from the following description of the method according to the invention, using at least one spherical clamp according to the invention.

A workpiece to be machined is clamped by a spherical clamp that is supported by a machine bed or braced with same. The fastening means at the shaft of the spherical clamp is connected to the workpiece, and in the clamped state of the spherical clamp is fixed relative to the machine bed (it being assumed that the workpiece in the machine bed is supported on at least one further engagement point of at least one further spherical clamp or a fixed clamping means, so that swivel movements of the workpiece about the fastening means, designed as a swivel bearing, are also prevented at the shaft of the spherical clamp). In this position the workpiece could have been initially clamped without tension and then machined, which could release internal stresses that would deform the workpiece when it was not braced in the clamping position via the spherical clamp. The internal stresses in addition to the possible clamping forces then act on the spherical clamp.

A first method step a) according to the invention provides that the spherical clamp is transferred from the clamping state into the released state to allow the workpiece or a workpiece section, starting from the clamping position provided in the clamped state, to automatically deform or move relative to the spherical clamp in question into a compensating position, thus reducing or eliminating the stresses prevailing between the workpiece and the spherical clamp. The clamping state could be released, for example, by the action of pressure on one or more radial springs which via radial contraction eliminate the clamping force on the ball socket, the ball clamp, and the shaft that is generated in the clamped state. In this state, the shaft together with its portion of the fastening means fixedly connected thereto is freely swivelable and displaceable relative to the machine bed. The portion of the fastening means connected to the workpiece, for example a fixing pin that is not displaceable but is swivelable relative to the shaft, can thus take part in the compensating movement of the workpiece during the transfer from the clamping position into the compensating position, in any given rotational position and location in space. The shaft, which in the released state is then swivelably and displaceably supported in the spherical clamp, may be moved into a new position and swivel position relative to the housing of the spherical clamp or relative to the machine bed, following the movements of the workpiece or of the fastening element. The shaft quasi-automatically takes over the realignment of clamping means, which in the prior art is carried out manually and with a significant expenditure of time to allow a deforming workpiece to be reclamped.

In any case, limitations of these compensating movements would be provided by design constraints, for example the maximum possible swivel angle of the fastening means or of the ball clamp, or a maximum displacement path of the shaft along the ball clamp. However, since the internal stresses, depending on the size of the workpiece, are generally reduced by compensating movements in the range of a few millimeters or tenths of a millimeter, such limitations are mainly theoretical.

According to the invention, the compensating movement can take place without completely releasing the workpiece from the one or more spherical clamps. In particular, access to the machine bed or other manual effort is not necessary for enabling the deformation of the workpiece into the compensating position. Instead, this may occur solely by transferring the spherical clamp in question into the released state, which may be achieved, for example, by the greatest possible automation of the action of pressure on the radial springs. This represents a significant simplification and speeding up of the machining process.

The method according to the invention may be expanded by an additional method step b) subsequent to the transfer of the workpiece into the compensating position. At least one of the previously released spherical clamps is transferred back into the clamped state in order to once again fix the workpiece in the newly occupied compensating position relative to the machine bed. This may likewise be achieved in a particularly simple and automated manner using the spherical clamp according to the invention, for example by eliminating the previous action of pressure on the radial springs, so that they deform toward the shaft in the radial direction, and once again fix the shaft via the clamping forces which then act between the ball socket, ball clamp, and shaft. (This applies analogously if, instead of the radial springs, other clamping mechanisms that are nonmanually actuated via fluid, electromechanically, or in some other way are used and activated in order to selectively clamp the ball socket to the ball clamp and the shaft or release it therefrom.)

An additional method step c) according to a further embodiment of the method according to the invention encompasses machining of the workpiece after it has been fixed once again in the compensating position. This machining may be used in particular to correct any deformations during the transfer into the compensating position, or to machine the deformed workpiece to target dimensions.

Method steps a) through c) may also be repeated multiple times if necessary in order to also reduce internal stresses that are newly released in the workpiece by subsequent machining.

One particularly advantageous embodiment of the method provides that at least one section of the workpiece remains continuously connected to the machine bed during method steps a) through c) via a fixed clamping means. This at least one section that remains essentially stationary over the course of the entire method may be used as a reference point for machining steps that the workpiece undergoes after newly occupying a compensating position. In contrast, other sections of the workpiece may be releasably braced with the machine bed via spherical clamps according to the invention. During the transfer into the released state, the respective sections of the workpiece supported by a spherical clamp move relative to the at least one stationarily clamped section, whose position does not change.

The machining of the workpiece may in particular encompass cutting machining. However, the machining may additionally or alternatively encompass welding, adhesive bonding, soldering, bending, embossing, stamping, hammering, or roller forming.

The fixed clamping means via which the tool is to be continuously braced with the machine bed in one embodiment may likewise be a spherical clamp according to the invention which continuously maintains its clamped state during the individual method steps. Alternatively, this may involve some other clamping means known to those skilled in the art. The clamping chuck previously known from the prior art and described in German Patent application DE 10 2005 033 468 A1 is preferably conceivable.

Although a ball socket as well as a ball clamp preferably have a spherical surface for mutual clamping contact, this is not absolutely necessary. Alternatively, it may be sufficient when either only the ball clamp or only the ball socket has a spherical contact surface, while the respective other component may slide along relative to same via a suitable contact surface, and at the same time may be swiveled about the midpoint M. Thus, for example, instead of a spherical inner surface the ball socket could have one or more preferably slotted ring elements that tightly encircle the ball clamp and that are radially deformable. A ball clamp having a spherical surface could also protrude into a circular opening in the inner side of the ball socket, the opening having a smaller diameter than the spherical surface. In the clamped state, the opening with its edge is then pressed against the ball clamp and clamped.

The method may also advantageously be carried out using multiple spherical clamps that hold the workpiece at various sections. This may be necessary in particular for larger workpieces. Individual or all spherical clamps may selectively be transferred simultaneously or individually into the clamped state or released state to enable the particular workpiece section to deform into the compensating position.

### BRIEF DESCRIPTION OF THE DRAWINGS

One embodiment of a spherical clamp according to the invention as well as the carrying out of the method according to the invention are explained in greater detail below with reference to examples in the figures, which show the following:

FIG. 1 shows a spherical clamp according to the invention in a perspective sectional view;

FIG. 2 shows a spherical clamp from FIG. 1 in a sectional side view; and

FIGS. 3 through 6 show the sequence of the method according to the invention, based on simplified side views in a machine bed.

### DETAILED DESCRIPTION OF THE PREFERRED EMBODIMENTS

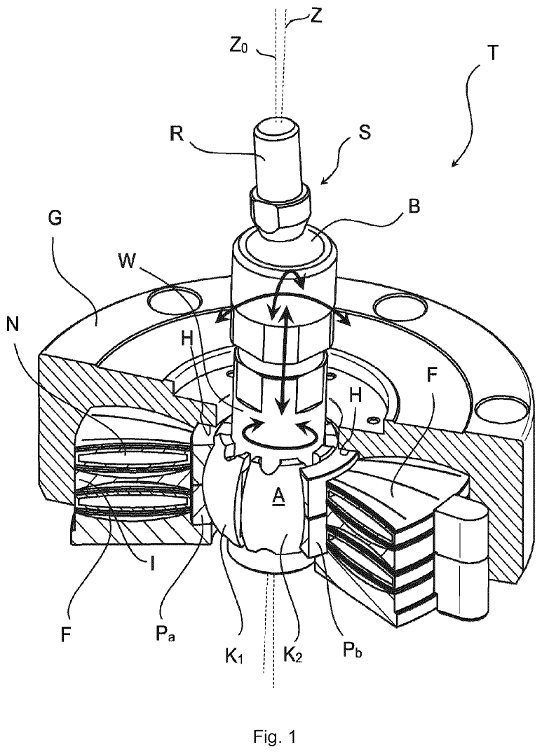

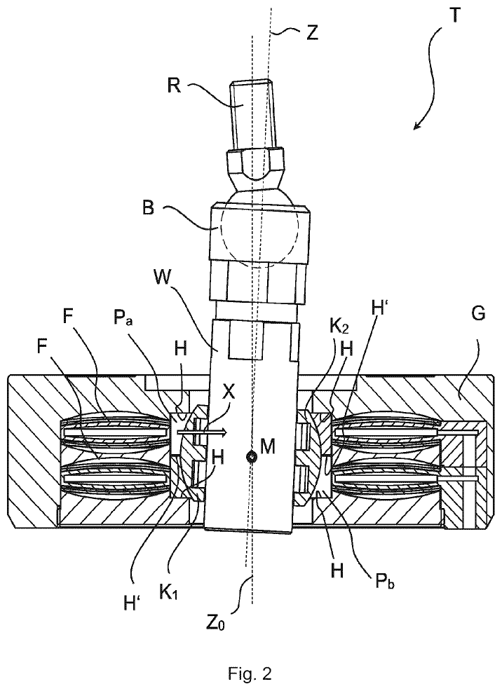

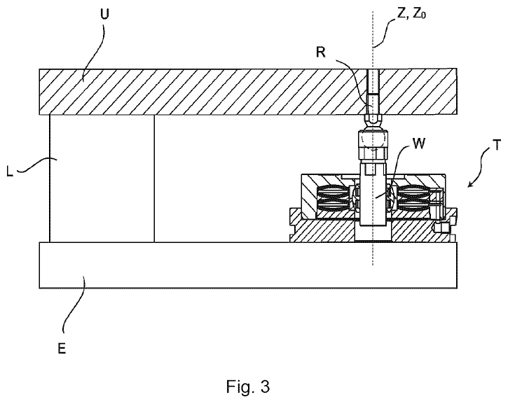

The spherical clamp T illustrated in FIGS. 1 and 2 includes a housing G having an essentially rotationally symmetrical design about a housing axis Z₀. The housing G may be clamped on a machine bed E via clamping means, not illustrated in greater detail, as shown by way of example in FIGS. 3 through 6.

Situated inside the housing G and around the housing axis Z₀ are two superposed radial springs F whose chambers N may be acted on by compressed air via connections, not illustrated in greater detail. At their outer circumference the radial springs F are supported inwardly in the radial direction on an inner wall I of the housing G. At their inner circumference the radial springs F adjoin a ball socket P that is formed from multiple individual ball socket elements Pₐ, P_{b} . . . situated around the housing axis in the circumferential direction. The radial springs are designed or pretensioned in such a way that in the relaxed state (no action of pressure on the chambers N) they have a maximum radial extension, and at their radial inner side exert a clamping force on the ball socket elements Pₐ, P_{b} . . . that acts toward the housing axis Z₀ (clamped state). When the chambers N are acted on by pressure, the radial springs F extend in parallel to the housing axis Z₀ and at the same time shorten in the radial direction, so that the clamping force on the ball socket elements is reduced or eliminated (released state).

On their inner side directed toward the housing axis Z₀, the ball socket elements Pₐ, P_{b} . . . form a spherical face for resting against a ball clamp K, which in turn is formed by individual ball clamp elements K₁, K₂ . . . , having a spherical outer face, situated around the housing axis. The center of curvature of the spherical inner face of the ball socket P and the outer face of the ball clamp K fitting tightly against same is the midpoint M, indicated in simplified form in FIG. 2. The ball socket P and the ball clamp K together form a ball joint in such a way that the ball clamp K is swivelable relative to the ball socket P and to the housing G, provided that no clamping force is transferred between the ball socket and the ball clamp that would result in locking static friction between the two components. The ball socket elements Pₐ, P_{b} . . . and the ball clamp elements K₁, K₂ . . . are each separated from one another in the circumferential direction by slots, so that when acted on radially by the radial springs, they may in each case be displaced slightly on the housing axis Z₀ toward the center.

With their inner side pointing toward the housing axis Z₀, the individual ball clamp elements together form an approximately cylindrical contact surface that tightly encircles a shaft that is formed around a shaft axis Z and centrally guided through the housing G. In the released state, the ball clamp elements exert no relevant clamping force on the cylindrical surface of the shaft W, so that the shaft is displaceable relative to the ball clamp elements in the direction of the shaft axis Z. A swivel movement of the shaft W relative to the housing G (or to a machine bed E supporting the housing) is also easily possible in the released state. In contrast, in the clamped state the ball socket elements Pₐ, P_{b} . . . are pressed inwardly in the radial direction (clamping direction X) against the ball clamp elements K₁, K₂., which exert a clamping force on the shaft W and thus fix it against twisting or moving relative to the housing G. In FIG. 2 the clamping direction X is indicated for a ball socket element Pₐ by way of example. Of course, each ball socket element has its own clamping direction, which is always directed toward the housing axis Z₀.

For play-free guiding of the ball socket elements Pₐ, P_{b} . . . , two mutually parallel stop surfaces H (see in particular FIG. 2) are formed in the housing G, between which the ball socket elements Pₐ, P_{b} rest, and are guided in the radial direction or supported in the axial direction. Both stop surfaces H are formed by rotationally symmetrical shoulders of the housing which extend circumferentially around the housing axis Z₀. The stop surfaces H ensure that the ball socket elements Pₐ, P_{b} . . . cannot yield perpendicular to the clamping direction X, and the guiding on both sides also prevents widening or flattening of the ball socket elements Pₐ, P_{b} . . . when acted on by pressure during the clamping. As a result, the ball socket elements Pₐ, P_{b} . . . are dimensionally stable and are pressed against the ball clamp K free of play. Resting in the spherical inner faces of the ball socket elements are the outer faces of the ball clamp elements K₁, K₂ . . . , which have a complementary or form-fit design with respect to same, so that the ball clamp elements K₁, K₂ are also indirectly guided and supported by the stop surfaces H. Therefore, the shaft W which is clamped by the ball clamping elements K₁, K₂ is likewise fixed free of play in the direction of the shaft axis Z or housing axis Z₀.

The ball socket elements Pₐ and P_{b} which are superposed in the direction of the housing axis Z₀ likewise form between them a stop surface H′ to support or stabilize one another in the axial direction.

A fastening means S in the form of a ball joint B is situated at an upper end of the shaft W. A lower section of the ball joint B is (preferably releasably) connected to the shaft W. An upper section of the ball joint B bears a fixing bolt R that is provided with a thread and a wrench flat. The fixing bolt R is fixed in position via the ball joint B, but is swivelably connected to the shaft W. Therefore, displacements of the fixing bolt R relative to the shaft W are not possible, whereas swivel movements are. As shown in particular in FIGS. 3 through 6, the fixing bolt R is used to connect a workpiece U to the shaft W, for example by screwing the fixing bolt R into a thread on the workpiece U provided for this purpose.

FIG. 1 illustrates the spherical clamp T in the released state. The chambers N of the radial springs F are acted on by pressure and widened, so that no clamping forces directed into the center are generated. Correspondingly, the shaft W is rotatable about its shaft axis Z relative to the housing G, is displaceable along its shaft axis Z, and is freely swivelable about the midpoint M, as indicated by the double arrows. The shaft axis Z may therefore also extend at an angle relative to the housing G, and does not have to coincide with the housing axis Z₀. However, both axes intersect at the midpoint M.

In contrast, FIG. 2 shows the spherical clamp T in the clamped state. Due to the clamping effect that is achieved on the shaft W that is guided in the center, the degrees of freedom indicated by the double arrows in FIG. 1 no longer exist, and the shaft W is instead rigidly connected to the housing and to the machine bed.

A machining process that utilizes a spherical clamp according to the invention is illustrated in simplified form in FIGS. 3 through 6. In FIG. 3 a workpiece U is provided for the machining, and for this purpose is braced with the machine bed E at one section via a fixed clamping means L. This clamping is continuously maintained over the course of the method, and is used as a reference point for individual machining steps.

A section of the workpiece U remote from the clamping means L is screwed with a fixing bolt R that is articulatedly connected to a shaft W of a spherical clamp T according to the invention. The spherical clamp is clamped to the machine bed E, and its radial springs may be acted on by compressed air via supply lines, not illustrated in greater detail, in order to selectively transfer the spherical clamp T from a clamped stated into a released state and back. In the example shown, the shaft axis Z initially coincides with the housing axis Z₀ in order to illustrate the subsequent transfer from the clamping position into the compensating position. By relaxation of the chambers N, the spherical clamp T may be transferred into the clamped state, utilizing the spring pretensioning that prevails in the radial springs, so that the section of the workpiece U supported by the spherical clamp T is stably clamped and ready for the machining.

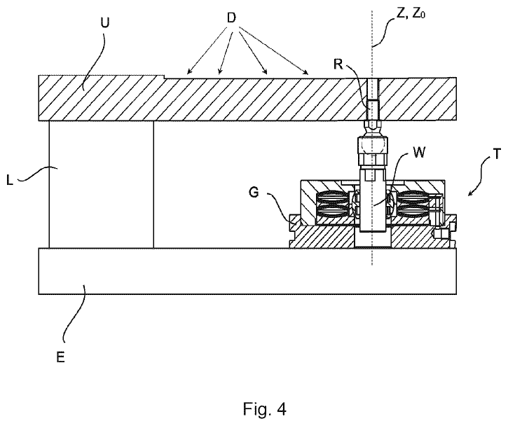

FIG. 4 shows how the workpiece U has been machined on a surface in a machining area D by use of a cutting process. This machining has released internal stresses, which subsequently seek to deform the workpiece U. However, due to the clamping via the spherical clamp T, this deformation is still prevented.

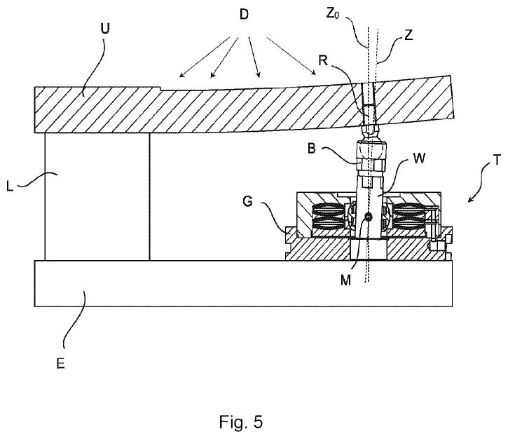

FIG. 5 shows the configuration of the workpiece U after the spherical clamp T has been transferred into the released state according to the invention. The clamping of the shaft W has thus been discontinued, and the clamping effect of the spherical clamp T on the workpiece U has been temporarily eliminated. Correspondingly, the workpiece U, as a result of the freed internal stresses, has been able to deform from the previous clamping position into a compensating position, as illustrated by the slight upward curvature of the machining area D. By means of the fixing bolt R, this movement has been transferred via the ball joint B to the shaft W and followed by it, so that the shaft W has been able to occupy a new position and orientation relative to the housing G. The shaft axis Z and the housing axis Z₀ now no longer coincide.

In the new compensating position, the machining no longer corresponds to the target dimensions, and finish machining is necessary. For this purpose, the workpiece must be fixedly reclamped in the compensating position to allow the workpiece to be remachined in the machining area D. According to the invention, this may easily take place by transferring the spherical clamp T from the released state back into the clamped state, thus automatically fixing the shaft W, together with the workpiece section which it supports, in its new position and orienting it relative to the housing G or to the machine bed E. Manual intervention for reclamping the workpiece in its changed position is advantageously not necessary.

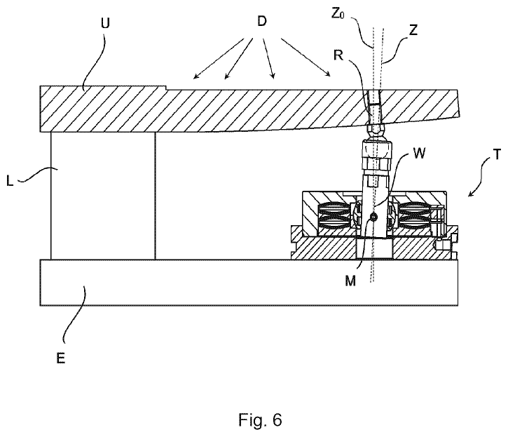

In this clamped state, illustrated in FIG. 6, the workpiece may therefore be reliably remachined, wherein the finish machining in the machining area D has now achieved the target dimensions. Assuming that this finish machining has released no additional internal stresses, the workpiece may be subsequently released from the fixed clamping means L and from the spherical clamp T without being deformed once again, and while maintaining the sought target dimensions. Alternatively, it would be conceivable to initially discontinue only the fixing at the spherical clamp T (transfer into the released state) and at the same time check the workpiece U for any further deformations or relative movements. If these reoccur, the stated method steps may be repeated until the target dimensions are within specified tolerances, even in the unclamped state.

### LIST OF REFERENCE SYMBOLS

A outer side of the ball clamp
B ball joint
D machining area
E machine bed
F radial spring
G housing
H stop surface
1 housing inner wall
K ball clamp
K₁, K₂ . . . ball clamp elements
L fixed clamping means
M midpoint of a spherically curved ball clamp outer side
N chamber of a radial spring
P ball socket
Pₐ, P_{b} . . . ball socket elements
R fixing pin
S fastening means
T spherical clamp
U workpiece
W shaft
X clamping direction
Z axis of the shaft (W)
Z₀ housing axis

1. A spherical clamp (T) for releasably clamping workpieces (U), including a housing that is provided around a central axis Z₀, and
a) including a shaft (W) that is provided around an axis (Z) and that has fastening means(S) at one end for fastening to the workpiece (U),
b) and including a ball clamp (K) which rests via clamping jaws, against a cylindrical section of the shaft (W), and the outer side (A) of the ball clamp facing away from its inner side has a spherical shape about a midpoint (M) situated on the axis (Z),
c) wherein a clamping mechanism having a ball socket (P) is provided, which at an inner side rests against the spherical outer side (A) of the ball clamp (K),
d) and wherein the ball socket (P) is movable from a clamped state in which it acts with a clamping force on the spherical outer side (A) of the ball clamp (K), in or opposite from a radial clamping direction (X) extending orthogonally with respect to the central axis (Z₀), into a released state in which the clamping force is reduced or eliminated,
e) wherein the shaft (W)
i) is displaceable relative to the ball socket (P) in the axial direction (Z) and/or rotatable about its axis (Z) and
ii) is swivelable about the midpoint (M)
in the released state but not in the clamped state,
f) and wherein the ball socket with a spherically shaped inner side rests against the spherical outer side of the ball clamp (K), and
g) wherein during the transfer between the clamped state and the released state, the ball socket (P) slides along at least one stop surface (H) that extends along the clamping direction (X) and that is preferably provided orthogonally with respect to the central axis Z₀, so that in the clamped state, the ball clamp (K) that is clamped by the ball socket (P), together with the shaft (W), is fixed, free of play, against movement perpendicular to the stop surface (H),
characterized in that
h) the ball socket has multiple ball socket elements (Pₐ, P_{b} . . . ) that are superposed in the direction of the housing axis (Z₀), and
i) the ball socket is designed to simultaneously act on the ball clamp above and below an equatorial plane.

2. The spherical clamp (T) according to claim 1, characterized in that the ball clamp (K) includes multiple ball clamp elements (K₁, K₂ . . . ) situated partially or completely separate from one another around the shaft in the circumferential direction.

3. The spherical clamp (T) according to claim 1, characterized in that for generating the clamping force, the ball socket (P) may be acted on in the direction of the axis (Z) or the midpoint (M) by pneumatically or hydraulically actuatable clamping means.

4. The spherical clamp (T) according to claim 1, characterized in that the ball socket (P) is formed from multiple ball socket elements (Pₐ, P_{b} . . .. ) that are partially or completely separate from one another and situated around the ball clamp in the circumferential direction.

5. The spherical clamp (T) according to claim 1, including a housing (G) for arrangement on a machine bed,
a) wherein clamping means in the housing (G), in the form of at least one radial spring (F), that may be acted on by a fluid and thus deformed are situated around the housing axis (Z₀),
b) and wherein with an inner section in the radial direction, the radial spring (F) is in operative connection with the ball socket (P, Pₐ, P_{b} . . . ), and with its radial outer end the radial spring is supported on a housing wall,
c) wherein the radial spring (F) in the clamped state generates a radially inwardly directed clamping force on the ball socket (P, Pₐ, P_{b} . . . ), as a result of which the ball clamp (K, K₁, K₂ . . . ) that is acted on by the ball socket (P, Pₐ, P_{b} . . . ) clamps the shaft (W) that is encompassed by the ball clamp, and ensures
against rotational movements around the shaft axis (Z), and
against swivel movements about the midpoint (M), and
against displacements in the direction of the shaft axis (Z) relative to the housing (G).

6. (canceled)

7. The spherical clamp (T) according to claim 1, characterized in that the fastening means(S) at the shaft (W) include a ball joint or a metal bellows with a fixing pin (R) that is swivelable relative to the shaft (W), the fixing pin (R) being designed for the releasable connection to a workpiece to be fixed.

8. A method for machining a workpiece (U), wherein by means of at least one spherical clamp (T) according to claim 1 the workpiece (D) is fixable relative to a machine bed (E), supporting the spherical clamp (T), via the fastening means(S) of the spherical clamp situated at the shaft (W), the method comprising the following step:
a) transferring the at least one spherical clamp (T) from the clamping state into the released state to enable the workpiece or a workpiece section, starting from a clamping position that is occupied in the clamped state, to automatically move into a compensating position relative to the spherical clamp (T) in question, and thus reduce or eliminate the stresses prevailing in the clamping position between the workpiece and the spherical clamp (T).

9. The method according to claim 8, wherein the following step is carried out after method step a):
b) transferring at least one spherical clamp (T), released in step a), back into the clamped state in order to once again fix the workpiece relative to the machine bed in the newly occupied compensating position.

10. The method according to claim 8, further comprising the following feature:
c) machining the workpiece while at least one spherical clamp (T) is in the clamped state, wherein the machining may encompass: cutting machining, welding, adhesive bonding, soldering, bending, embossing, stamping, hammering, or roller forming.

11. The method according to claim 8, wherein at least one section of the workpiece remains fixed to the machine bed via a stationary clamping means (L), while at least one spherical clamp (T) is released and reclamped according to method steps a) and b).

12. The method according to claim 10, wherein method steps a), b), and c) are carried out multiple times in succession before the workpiece is removed from the machine bed.

13. The method according to claim 11, wherein method steps a), b), and c) are carried out multiple times in succession before the workpiece is removed from the machine bed.
